(19) United States
(12) Patent Application Publication
(10) Pub. No.: US 2012/0245999 A1
(43) Pub. Date: Sep. 27, 2012

(54) SELECTION OF RELEVANT ADVERTISING FOR ANONYMOUS CUSTOMERS

(75) Inventor: Orla Hennessy, Skerries (IE)

(73) Assignee: NCR CORPORATION, Duluth, GA (US)

(21) Appl. No.: 13/069,949

(22) Filed: Mar. 23, 2011

(51) Int. Cl. G06Q 30/00

(52) U.S. Cl. 705/14.53

(57) ABSTRACT

A marketing system for making presentations to customers in a retail store. 3-D object recognition techniques are used to identify articles which a customer has selected for an impending purchase. Age and gender of the customer are also inferred. The identities of the articles are used to make a prediction regarding (1) an upcoming activity, or (2) characteristics of the customer. Based on the prediction, advertising is selected for the customer, which promotes goods or services which relate to the activity or characteristics predicted. The inferred age and gender can assist in the selection.

The invention concerns an approach to selecting advertising for unidentified customers in a shop, which advertising is nevertheless relevant to the unidentified customers.

### BACKGROUND OF THE INVENTION

People in the industrialized countries are continually exposed to advertising. This exposure is believed by some to induce a sensory overload in those people, causing them to become market-resistant, with a tendency to ignore the advertising.

It is possible that an overload of advertising itself is not the actual cause of the market resistance, but instead the cause may be an overload of advertising which is irrelevant. That is, it is possible that when people are exposed to large amounts of advertising which is not relevant to their affairs, they respond by suppressing recognition of all, or most of it.

The invention proposes a system which identifies characteristics of shoppers, in order to select advertising which is relevant to those characteristics. Further, the shoppers are not identified, and remain anonymous, yet relevant advertising is selected for them.

### OBJECTS OF THE INVENTION

An object of the invention is to provide an improved approach to marketing.

Another object of the invention is to provide a system which selects advertising for presentation to a person, based on inferred preferences of the person, while not identifying the person.

### SUMMARY OF THE INVENTION

In one form of the invention, merchandise which has been selected by a shopper for purchase is identified, as by 3-dimensional object recognition. The identified merchandise is then classified, in order to infer (1) characteristics of the customer and/or (2) future events in the life of the customer, in which the identified merchandise will be involved. But the customer may not be identified, and may remain anonymous. Advertising is then selected which is relevant to the future events or the characteristics, as the case may be, and is presented to the customer.

### BRIEF DESCRIPTION OF THE DRAWINGS

FIG. 1 illustrates a shopper in a retail establishment, who is carrying items of merchandise, which he will purchase.

FIGS. 2 and 3 illustrate processes undertaken by one form of the invention.

FIG. 4 illustrates relative positioning of an optical camera C with respect to a shopping basket B.

### DETAILED DESCRIPTION OF THE INVENTION

### Overview

The invention observes a customer in a store, and identifies items which have been selected for upcoming purchase by the customer, as by using 3-D object recognition. The detection may be done at a self-service check-out station, or elsewhere. The identities of the items are used to select advertising to present to the customer on digital signage, such as on an LED screen located at a checkout station or elsewhere.

The particular advertising selected may be based on inferences drawn about the customer, based on the collection of items detected. For example, if the customer is seen to be purchasing party supplies, then advertising for additional party supplies may be presented, such as newly available champaigne.

This selection of advertising can be viewed as being based on the inference of a predicted upcoming event in the customer's life, namely, a social gathering.

In addition, the selection of advertising may also consider the age and gender of the customer, which are inferred using known methods.

In one form of the invention, no identification of the customer is made. The customer remains anonymous. Specifically, no loyalty card, credit card, or other identifying token of the customer is consulted or examined by one form of the invention. Consequently, in this form of the invention, no background information or stored profile of the customer is consulted (because, of course, the identity of the customer is not known).

Instead, the selection of advertising is made based on any, or all, of three pieces of information, namely, (1) the inferred gender of the customer, (2) the inferred age of the customer, and (3) the identities of items in the possession of the customer.

As to item (3), it is possible that all items in the possession of the customer cannot be identified, in which case, the selection process is based on the subset of items which has been successfully identified.

It is pointed out that, in one form of the invention, the identification processes are “open loop,” in the sense that no feedback is used to ascertain the correctness of the assessments made as to age, gender, and identity of products. Thus, the identification processes may more correctly be described as inferences, rather than identifications.

### Detailed Discussion

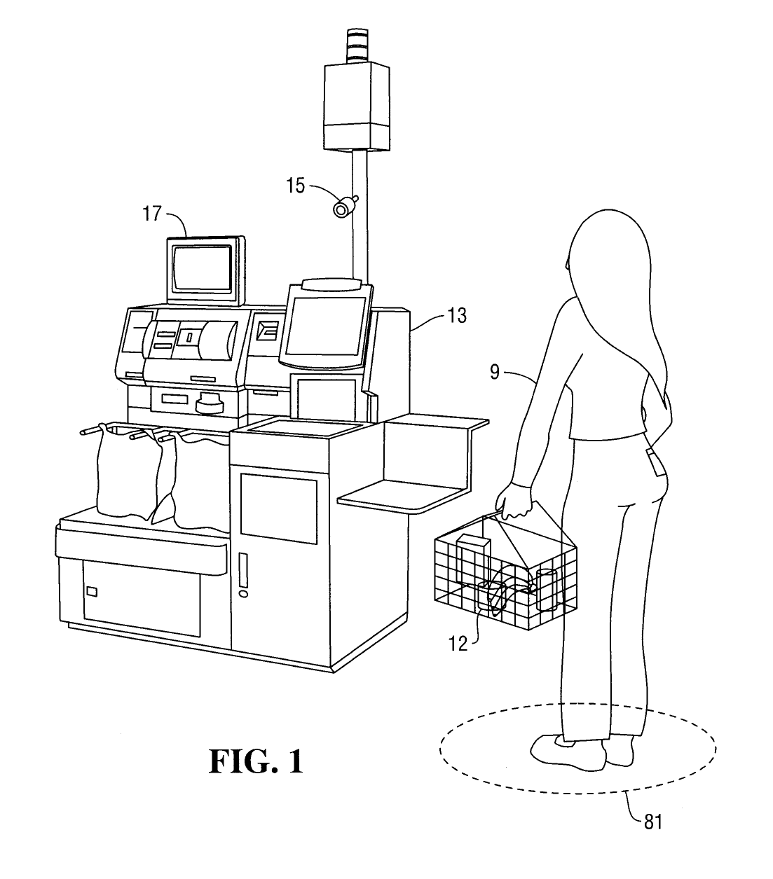

FIG. 1 shows a person 9 carrying three objects or items 12. The person 9 is located in a retail establishment, and has selected the objects 12 from shelves (not shown), or other displays, for impending purchase at a self-service check-out station 13. The objects 12 could also be contained in a basket or wheeled cart (neither is shown) which is carried or pushed by the person 9.

A detector 15, known in the art, detects the identities of the objects 12. In one approach, three-dimensional (3-D) object recognition can be used, as known in the art. In another approach, the detector 15 can locate labels (not shown) on the objects 12, and then use pattern recognition and character recognition processes to obtain textual information from the labels, to identify the objects 12. These recognition processes can be combined with the 3-D object recognition.

If it is found that many of the objects 12 belong to a similar brand, or originate from a common manufacturer, then it may be inferred that the customer is interested in that brand or manufacturer. In this case, advertising is selected which promotes that brand family or manufacturer, as explained below.

The detector 15 can also implement other approaches to detecting the objects 12. For example, RFID tags may become sufficiently inexpensive that they are considered disposable. In this case, the objects 12 may be tagged with disposable RFID tags, which identify the objects. The detector 15 can identify the objects 12 through remotely reading the tags.

This approach can also be applied if an infra-structure is developed in which RFID tags are re-cycled, as opposed to being disposable. Some of the RFID tags (not shown) on the items 12 may have been re-cycled.

In another approach, the detector 15, either by itself or paired with one or more other detectors (not shown) can remotely read bar codes, also called UPC (Uniform Product Codes) codes, which are contained on the objects 12. For example, the detector 15 can be equipped with a telescopic lens on a camera, for UPC recognition.

Therefore, as so far described, a detector 15 identifies objects 12 in a collection of objects which are associated with a customer 9. The objects 12 can be carried by the customer 9, as shown, carried in a hand-basket, carried in a wheeled cart (not shown), or otherwise conveyed by the customer 9.

It is pointed out that all of the objects 12 in the collection need not be identified, but preferably an attempt is made to identify them all. For example, some objects may lie concealed behind, or under, other objects, and thus not be visible to a detector 15 which relies on optical methods to identify the objects. When all the objects 12 of the customer 9 are not identified, the processes described herein are applied to those which have actually been identified, or to a subset of those.

After the objects have been identified, an analysis step is undertaken, in which information is derived from the nature of the objects. This information allows (1) inferences to be drawn about the customer 9, (2) predictions to be made about future behavior of the customer, and (3) classifications to be made about expected behavior of the customer.

For example, inquiry may be made as to whether some, or all, of the objects 12 share common traits. The traits identified may suggest an interest of the customer 9, and thus lead to a choice of advertising. The advertising is presented on a video screen 17 in FIG. 1. The screen 17 can be located at the check-out station 13 as indicated, or elsewhere, as can be the detector 15.

In one form of the invention, the screen 17 is dedicated exclusively to displaying the advertising, and does not participate in any other functions, such as participating in Point of Sale (POS) functions, as by displaying items purchased, their prices, total prices, and so on, which it does not do, as just stated.

The precise nature of the inferences derived will depend on the marketing strategy used by the party who is utilizing the invention, and some examples will be given here.

### EXAMPLE 1

Assume that the customer is in a supermarket, and the objects 12 are found to contain (1) a large number of fresh fruits and vegetables, (2) little or no red meat, and (3) no canned goods. A plausible inference based on this collection of objects is that the customer 9 is sympathetic with a modern medical theory that fresh fruits and vegetables are beneficial to one's health. Another inference may be that the customer prefers vegetarian foods.

Accordingly, advertising which is consistent with these inferences may be appropriate. A specific example may be an advertisement for a cookbook for healthy foods. A specific counter-example may be to avoid an advertisement for sliced bacon.

### EXAMPLE 2

Assume that the customer is in a home center, or lumber yard, and that the objects indicate that larger-than-average quantities of certain items are being purchased. For example, a large quantity of paint may be detected among the objects 12.

The purchase of paint may lead to the inference that the customer 9 owns a large house, which gives demographic information about the customer. Or it may lead to the inference that the customer is a painting contractor.

In this example, the single item (the paint) may be indeterminate: it may indicate that the customer owns a large house, or is a painting contractor. Thus, the single item is not necessarily helpful in leading to a selection of advertising, unless the advertising relates to products which all paint users would want, such as paint thinner.

However, if the customer 9 in addition purchases a large quantity of drop cloths, that may lead to the inference that the customer 9 is not a painting contractor, because a painting contractor, in general, will possess his own drop cloths, and they would probably durable and re-usable. These facts would militate against the conclusion that the drop cloths are being purchased by a painting contractors. Similarly, if the customer 9 purchases paint brushes, that may again lead to the inference that the customer 9 is not a painting contractor.

Different advertising will be selected for an individual homeowner, as compared with a painting contractor.

Therefore, the invention attempts to derive information about the customer 9, based on the identities of the objects 12. Then, based on that derived information, advertising is selected.

### EXAMPLE 3

Assume that the customer 9 is in a supermarket, and purchases a large quantity of party foods, such as potato chips. This purchase may support either the inference that (1) the customer has a large family, or (2) is planning an entertainment event.

If the customer 9 is detected as also purchasing a quantity of adult beverages, that fact would support the inference of an upcoming entertainment event. Based on that inference, advertising is selected which is suitable for a party-planner.

Therefore, as so far described, the invention (1) identifies objects being purchased by a customer, (2) uses one or more of the objects to deduce information about the customer, (3) based on the information deduced, predicts additional merchandise which the customer may desire, (4) selects advertising from storage which relates to the additional information, and (5) presents the selected information to the customer.

Significantly, the invention also rejects certain advertising as unsuitable, and does not present that advertising, as in the bacon-example given above.

### SPECIFIC EXAMPLE

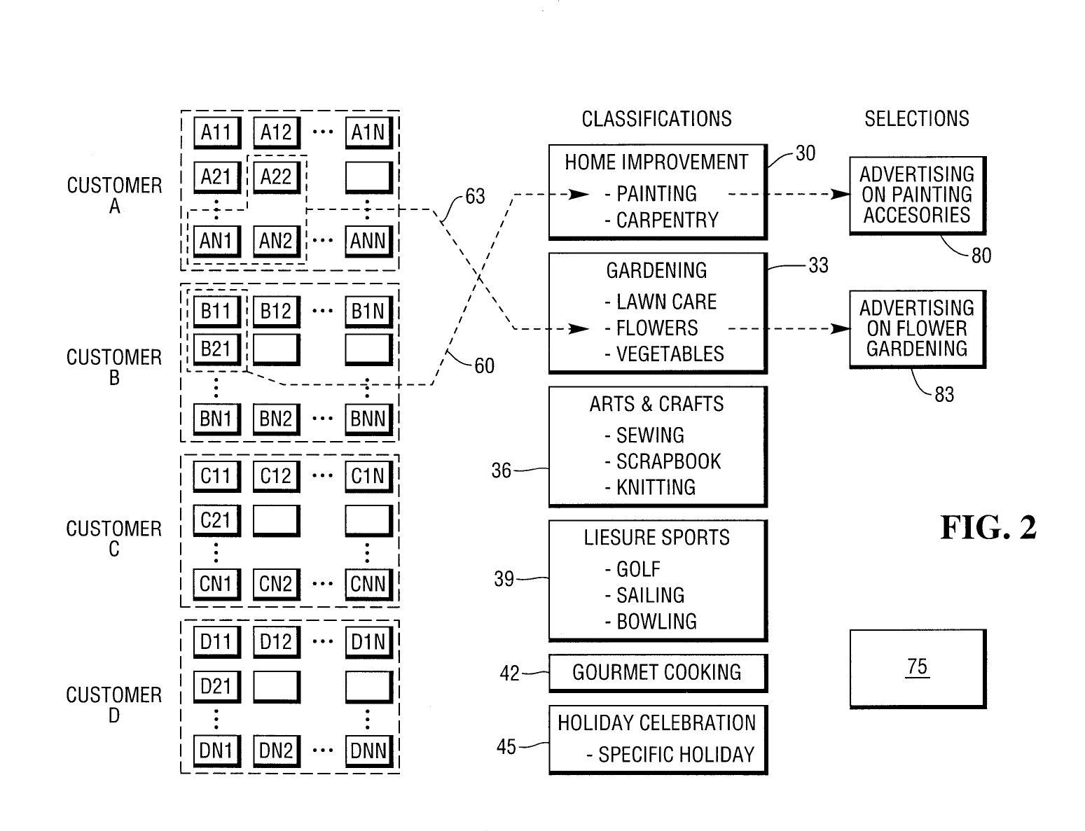

FIG. 2 is a specific example of processes undertaken by one form of the invention. The left-hand column illustrates groups of items which are associated with customers A, B, C, and D. For example, items A11 through ANN are associated with customer A. These items correspond in principle to the items 12 in FIG. 1. Some or all of those items have been identified as described above.

The central column illustrates part of a classification scheme which is developed by a user of the invention. The customer is classified into one, or more, of the blocks in that column.

Block 30 indicates that a customer is interested in, or involved in, home improvement. Sub-classes of painting and carpentry are indicated.

Block 33 indicates that the customer is interested in gardening, and the sub-classes of lawn care, flower gardening, and vegetable gardening are indicated.

Block 36 indicates that the customer is interested in arts and crafts, with the sub-classes of sewing, scrapbooking, and knitting being indicated.

Block 39 indicates that the customer is interested in leisure sports, with the sub-classes of golf, sailing, and bowling being indicated.

Block 42 indicates that the customer is interested in gourmet cooking. Sub-classes representing different styles of ethnic cooking, or cooking characteristic of different cultures or nationalities could be present.

Block 45 indicates that the customer is involved in a holiday celebration, and the sub-class of a specific holiday, such as Thanksgiving or Halloween in the United States, can be indicated.

Arrow 60 indicates that items B11 and B21 associated with customer B lead to the conclusion that customer B is involved in painting as a home improvement project. Items B11 and B21 were identified as described above. Accordingly, advertising deemed to be of interest to customer B is selected, and block 80 indicates that specific advertising relating to painting accessories is selected. This advertising is presented to customer B on the video screen 17 shown in FIG. 1, or located elsewhere in the store.

Similarly, arrow 63 indicates that items A22, AN1 and AN2 associated with customer A lead to the conclusion that customer A is involved in flower gardening. Items A22, AN1, and AN2 were identified as described above. Accordingly, advertising deemed to be of interest to customer A is selected, and block 83 indicates that specific advertising relating to flower gardening is selected. This advertising is presented to customer A on the video screen 17 shown in FIG. 1, or located elsewhere in the store.

A similar process is undertaken for each of the other customers in FIG. 2.

It is pointed out that a multi-step process is undertaken by the form of the invention under consideration. One, objects associated with the customer are identified. Those objects are most likely items selected by the customer for purchase in a retail store.

Two, the age, gender, or both age and gender of the customer may be inferred. In the examples of FIG. 2, the age, gender, or both, bay be taken into account when selecting the advertising. This can be done using population statistics derived from surveys and polling. For example, as to the arts and crafts classification of block 36, statistical data can be obtained which indicates the average age of persons interested in sewing, knitting, etc. The inferred age of the customer is then matched with those average ages, to predict the customer's interests.

As a third step, a classification of interests, activities, or associations of the customer is made, based on one or more of the objects identified. Arrows 60 and 63 indicate this classification step. In one form of the invention, two or more items which support a classification are required, before a classification is made.

For example, under this rule, if a single packet of flower seeds, without corroborating items, is found in the items of customer A, that single packet by itself is insufficient to support a classification. However, if, in addition, flower potting soil is identified, then the classification indicated by arrow 63 would be undertaken.

This classification step can also be viewed as formulating a prediction about the customer's future activities, or about upcoming events in the customer's life. For example, if it is inferred that the customer is interested in sailing in block 39, then the prediction may be warranted that the customer will go sailing on a boat in the future.

Four, based on the classification, advertising suitable to the classification is selected and presented to the customer. Block 75 in FIG. 2 represents storage locations in which the advertising is stored, as well as the computer systems which perform the processes described herein.

Significantly, in one form of the invention, the advertising can be restricted in several ways. One, the advertising preferably does not relate specifically to the items detected in a customer's group, because that would be redundant. For instance, advertising which describes the flower seeds which have been identified would not be presented. But advertising which relates to flower seeds generally may be appropriate.

Two, the advertising selected should accommodate presumed preferences suspected in the customer. The avoidance of presenting advertising on sliced bacon to a vegetarian, as mentioned above, provides one example. As another example, assume that the customer was classified as interested in sailing in block 39 in FIG. 2. It is believed that some people interested in sailboats possess an aversion to motorized boating. Therefore, advertising selected for the specific customer may avoid references to motorized boating.

This element Two can be summarized by the restriction that certain negative rules of advertising are associated with some classifications, and those negative rules prohibit presentation of certain advertising (call it Type A) to certain customers, while Type A advertising is, in fact, presented to other customers.

### Flow Chart

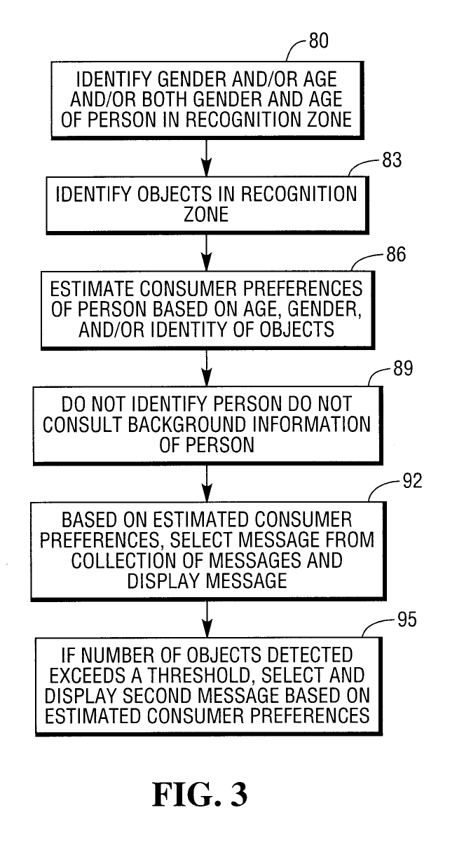

FIG. 3 is a flow chart illustrating processes undertaken by one form of the invention. The processes need not be undertaken in the order indicated, and not all processes indicated in FIG. 3 need be used by a specific implementation.

Block 80 indicates that the computer system 75 in FIG. 2 identifies the age, gender, or both, of a person, such as person 9 in FIG. 1, within a recognition zone 81. The size and location of the recognition zone 81 is determined by the capabilities of the detector 15. It is noted that the age and gender of the person need not always be inferred.

Block 83 in FIG. 3 indicates that the detector 15, and the associated computer system, represented by block 75 in FIG. 2, identifies objects 12 in FIG. 1.

Block 86 can refer to the classification step discussed in connection with FIG. 2. The identities of the objects 12 in FIG. 1 are used to infer (1) preferences of, (2) characteristics of, and/or (3) future events expected for, the person 12. This inference can also be based on the estimated age and gender of the person.

Block 89 refers to a specific feature of one form of the invention, in which the person 12 in FIG. 1 is not identified by name, and so no file or profile of that unidentified person is available for consultation. The person 12 remains anonymous.

Block 92 in FIG. 3 indicates that advertising is selected and displayed, as on video display 17 in FIG. 1, based on the inferred preferences of the customer.

Block 95 indicates that, if the number of objects detected with a given customer exceeds a limit (that is, the customer makes a large purchase), then a second classification process like the first can be undertaken, and second advertising presented to the customer.

### Additional Considerations

1. It is emphasized that the identification need not be 100 percent accurate and, in fact, probably will not be 100 percent accurate. Perfect accuracy is not required in order for the invention to be valuable.

2. The detector 15 shown in the Figures represents a detection system. If the system is a 3-D object recognition system, then the detector 15 represents an optical camera, together with the associated processing equipment, such as one or more micro-computers, and the associated software.

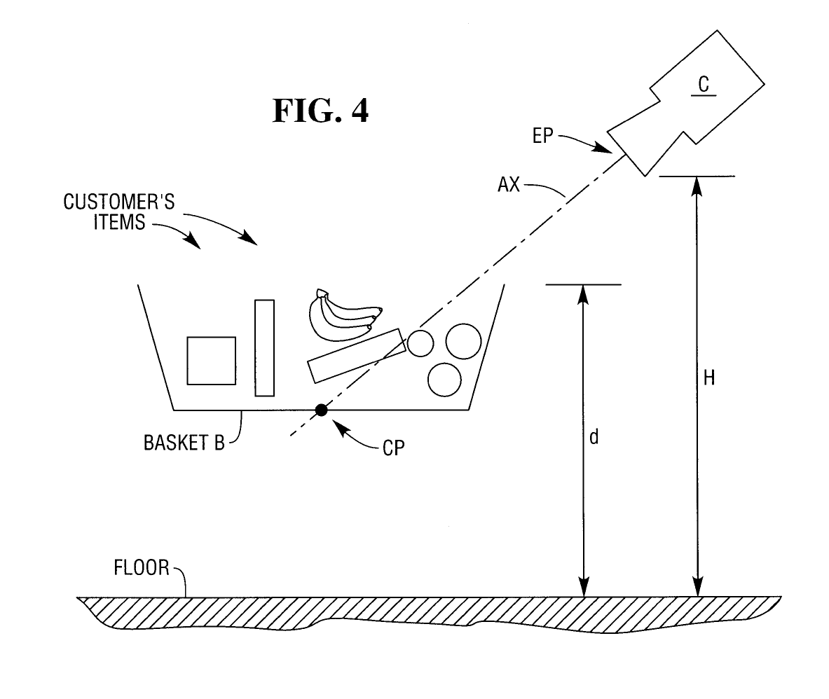

3. In FIG. 4, the CUSTOMER'S ITEMS are shown as carried in a basket B. The basket B may be a hand-basket, or a wheeled cart (wheels are not shown). In one form of the invention, it is preferred that the optical axis AX of the camera C intersect a central point CP of the bottom of the basket B. This will facilitate imaging the items.

Thus, in this form of the invention, in the case where basket B is a hand-basket, distance d will be of the order of two feet. Thus, distance H, which is the distance between the entrance pupil EP of the camera C and the floor, must be at least four feet, and will be greater as the horizontal distance between the basket B and the camera C increases.

Similarly, in the case where basket B is a wheeled shopping cart, distance d will be of the order of four feet. Thus, distance H must be at least six feet.

4. When a person purchases merchandise at a retail store, a POS (Point of Sale terminal) staffed by a clerk, or a self-service POS reads bar codes on the merchandise, and thus identifies the merchandise. In one form of the invention, the identification of the merchandise is not done during check-out, and thus differs from the identification described in the previous sentence. Instead, the identification is made before check-out. Further, the identifications made are not used in the check-out process, and are not used to determine the customer's billing.

Numerous substitutions and modifications can be undertaken without departing from the true spirit and scope of the invention.

What is desired to be secured by Letters Patent is the invention as defined in the following claims:

1. A system, comprising:
a) a detection system which identifies items associated with a customer located in a retail establishment, using 3-D object recognition;
b) a classification system which predicts a future activity of the customer, based on one or more of the items identified;
c) a group of previously prepared advertisements held in storage; and
d) a system which
i) selects an advertisement from the group, which promotes a product or service related to the future activity, and
ii) presents the advertisement to the customer.

2. A system according to claim 1, in which identification of the items is based exclusively on 3-D object recognition.

3. A system according to claim 1, in which the detection system further infers gender of the customer.

4. A system according to claim 1, in which the detection system further infers age of the customer.

5. A system according to claim 3, in which the gender inferred influences selection of the advertisement.

6. A system according to claim 3, in which the age inferred influences selection of the advertisement.

7. A method, comprising:
a) without human intervention, identifying items associated with a customer located in a retail establishment, using 3-D object recognition;
b) predicting a future activity of the customer, based on one or more of the items identified;
c) selecting an advertisement from a collection of advertisements, which promotes a product or service related to the predicted future activity; and
d) presenting the advertisement to the customer.

8. Method according to claim 7, in which identification of the items is based exclusively on 3-D object recognition.

9. Method according to claim 7, and further comprising the step of inferring gender of the customer.

10. Method according to claim 7, and further comprising the step of inferring age of the customer.

11. Method according to claim 9, in which the gender inferred influences selection of the advertisement.

12. Method according to claim 10, in which the age inferred influences selection of the advertisement.

13. System according to claim 1, in which the customer is not identified.

14. Method according to claim 7, in which the customer is not identified.

15. A method of presenting advertising to an anonymous customer, comprising:
a) inferring identities of articles selected by the customer within a retail store, prior to presentation at a check-out station;
b) based on some of the identities, making a prediction as to a future event to be undertaken by the customer;
c) based on the prediction, selecting advertising from a collection of stored advertising; and
d) presenting the selected advertising to the customer.

16. Method according to claim 16, in which the advertising selected describes a good or service usable in connection with the future event.

17. Method according to claim 16, in which no credit card, nor loyalty card, nor other token of the customer is used to identify the customer.
